(19) United States
(12) Patent Application Publication
(10) Pub. No.: US 2011/0315842 A1
(43) Pub. Date: Dec. 29, 2011

(54) HOLDER WITH REPLACEABLE LOAD BEARING PART

(75) Inventor: Yu-Chen LIN, Taichung County (TW)

(73) Assignee: SUN-CASTLE GLOBAL PRECISION TECHNOLOGY CO., LTD., Taichung (TW)

(21) Appl. No.: 12/822,372

(22) Filed: Jun. 24, 2010

(51) Int. Cl. F16M 13/02

(52) U.S. Cl. 248/222.14; 248/205.1

(57) ABSTRACT

A holder includes a base plate adapted to secure to a vertical surface and comprising two locking units on a front surface; and a load bearing assembly comprising a load bearing member, a load bearing element projecting forward from the load bearing element; and a plate member releasably secured to the load bearing element. The locking units are releasably fastened between the load bearing member and the plate member. The load bearing member can be replaced with a new one or one having a different load bearing element.

### BACKGROUND OF THE INVENTION

1. Field of Invention

The invention relates to holding devices and more particularly to a holder having a replaceable load bearing part.

2. Description of Related Art

Holders are widely employed. For example, there are tissue holders, tumbler holders, hook holders, etc. A typical holder 1 is shown in FIG. 1 and comprises a rectangular base plate 11 including two apertures 12 on two upper corners respectively, a hook 13 formed integrally with the base plate 11 or soldered thereto, and two screws 14 to be driven through the apertures 12 into a wall respectively. In use, a person may hang, for example, clothes on the hook 13.

However, a number of drawbacks have been found in the typical holder 1. For example, it is impossible of replacing the exiting hook 13 with another one since the hook 13 is fixedly secured to the base plate 11 if such need arises (e.g., damage). Further, it is time consuming by threadedly unfastening the screws 14 if a person wants to detach the holder 1 from the wall. Moreover, a tool (e.g., screw driver) is required for the mounting or disassembly of the holder 1. This is inconvenient if no tool is available. In addition, the whole holder 1 will be discarded and replaced with a new one if only, for example, the hook 13 is damaged. This is not cost effective. Thus, the need for improvement still exists.

### SUMMARY OF THE INVENTION

It is therefore one object of the invention to provide a holder comprising a base plate adapted to secure to a vertical surface and comprising two locking units on a front surface; and a load bearing assembly comprising a load bearing member, a load bearing element projecting forward from the load bearing element; and a plate member releasably secured to the load bearing element, wherein the locking units are releasably fastened between the load bearing member and the plate member.

The above and other objects, features and advantages of the invention will become apparent from the following detailed description taken with the accompanying drawings.

### BRIEF DESCRIPTION OF THE DRAWINGS

FIG. 1 is a perspective view of typical holder to be mounted on a wall;

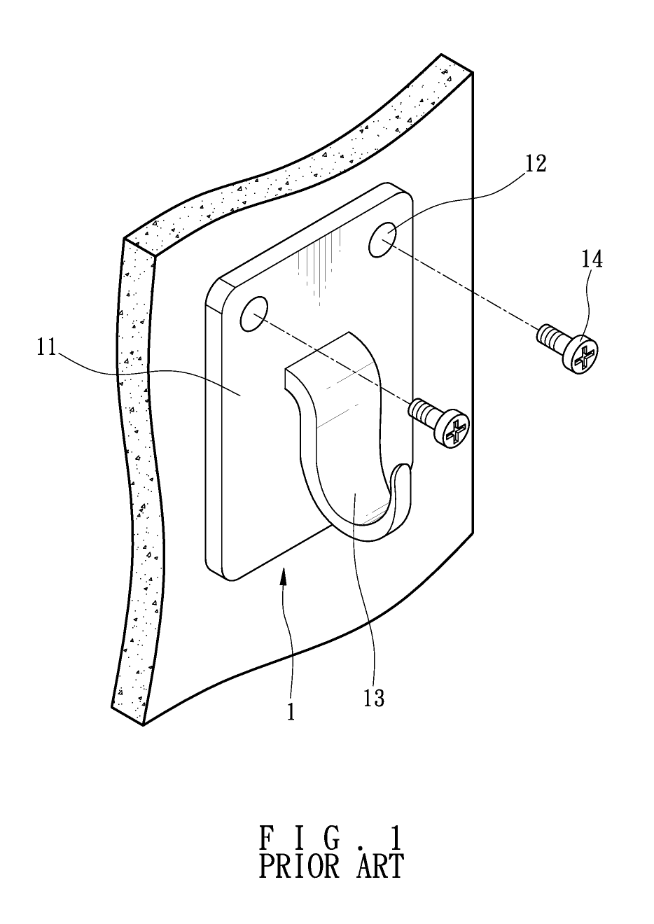

FIG. 2 is an exploded view of a holder according to the invention;

FIG. 3 is an exploded perspective view of the holder of FIG. 2;

FIG. 4 is a perspective view of the holder of FIG. 2 being mounted on a wall;

FIG. 5 is a perspective view but viewing from an angle opposite to that of FIG. 4 with the holder mounted on the wall;

FIG. 6 is a plan view viewing from the right side of FIG. 5;

FIG. 7 is a view similar to FIG. 5 showing the holder being mounted on the wall;

FIG. 8 is a plan view viewing from the right side of FIG. 7 showing a mounting of the load bearing assembly;

FIG. 9 is a view similar to FIG. 4 showing the holder mounted on the wall;

FIG. 10 is a view similar to FIG. 8 showing a disengagement of the load bearing assembly;

FIG. 11 is a perspective view showing the load bearing assembly detached from the holder; and

FIG. 12 is a perspective view showing the holder having a retainer ring for holding a cup as a replacement of the hook according to another configuration of the invention.

### DETAILED DESCRIPTION OF THE INVENTION

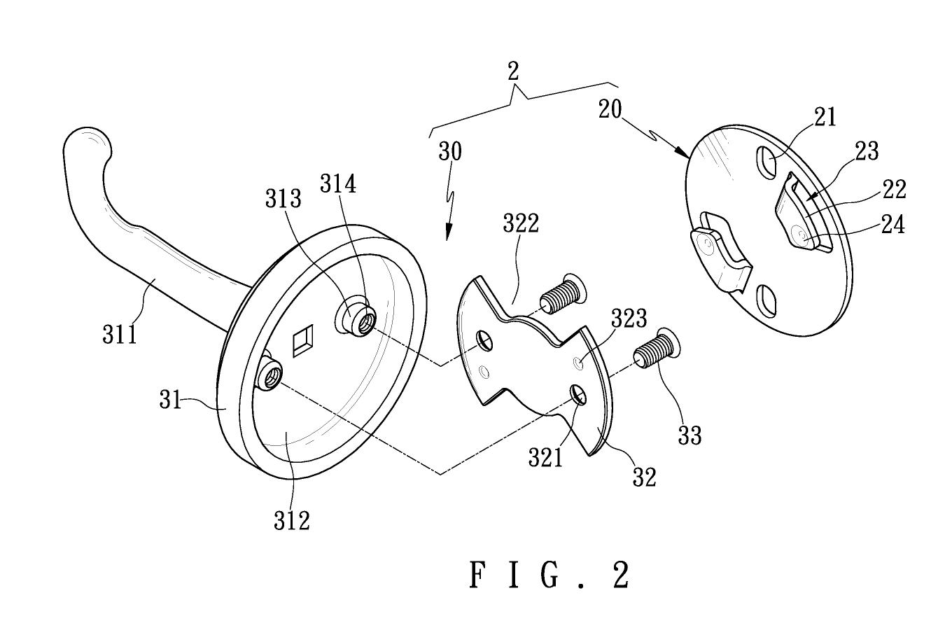

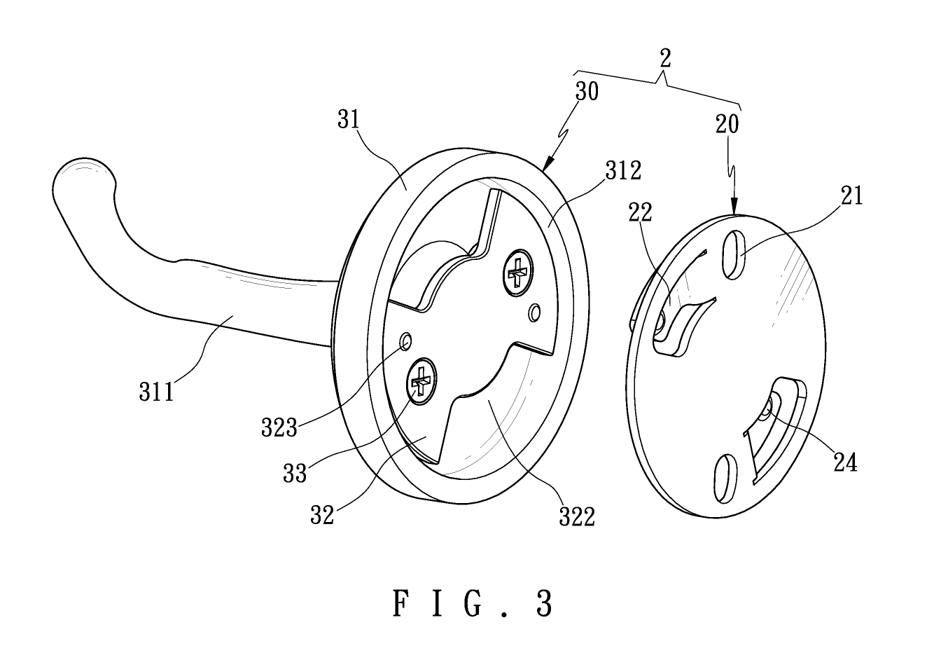

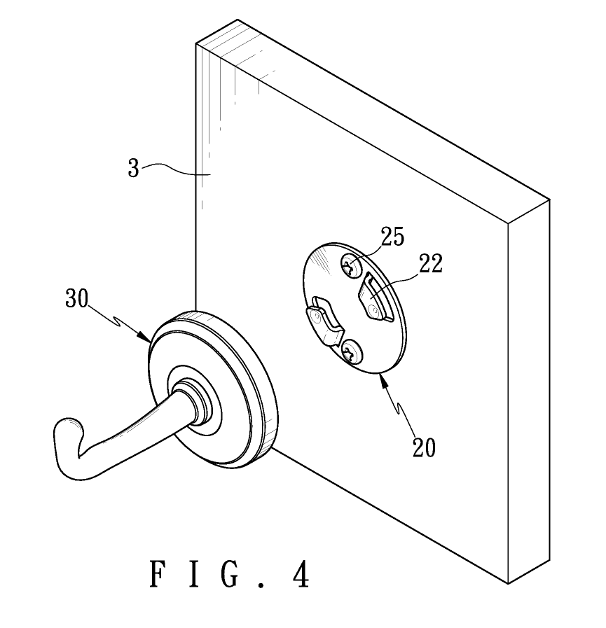

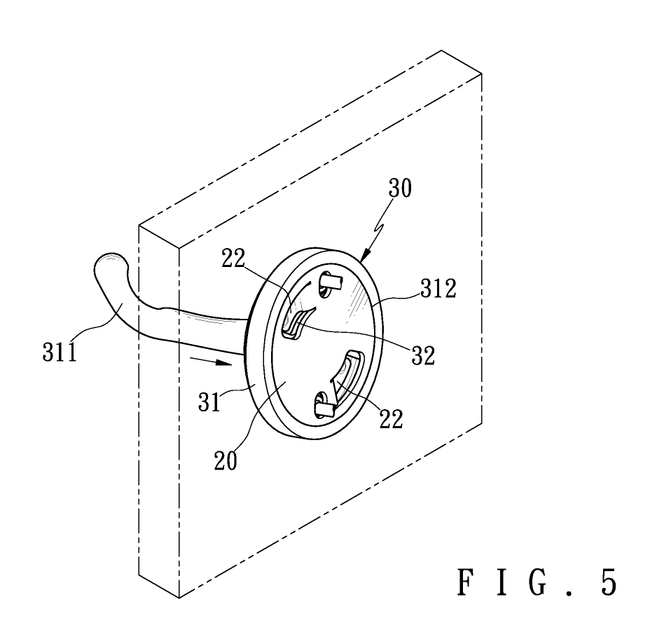

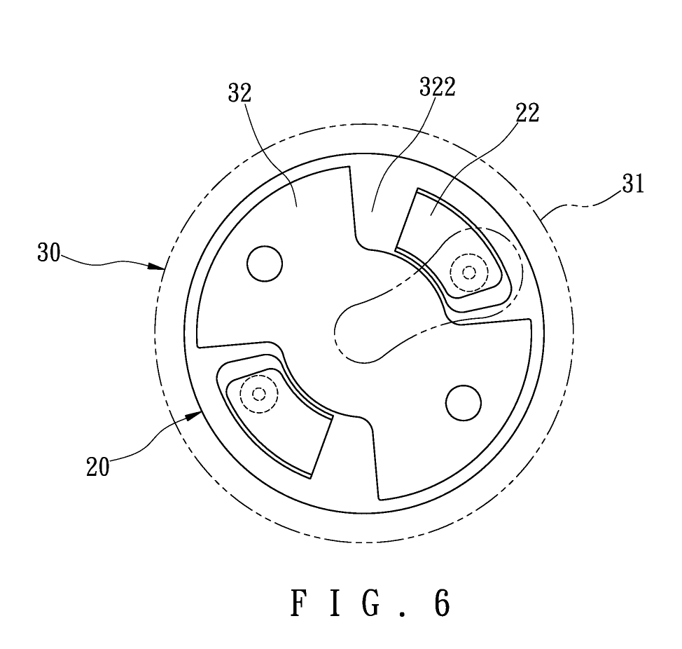

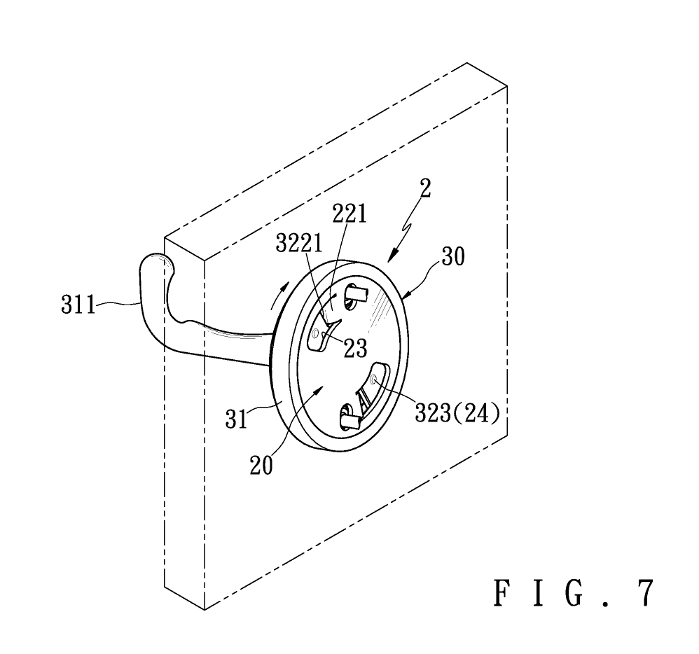

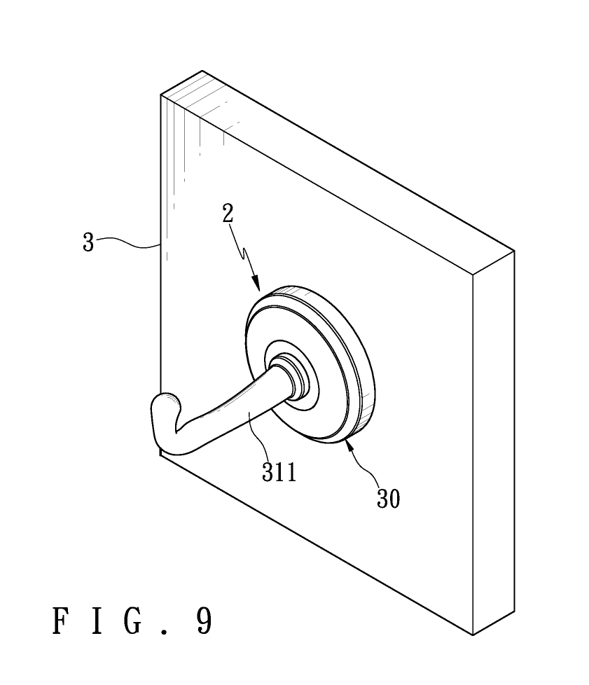

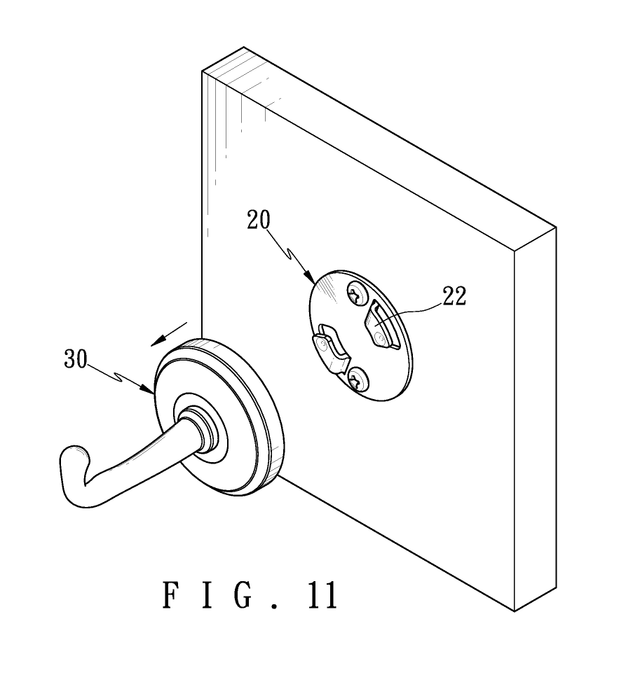

Referring to FIGS. 2 to 11, a holder 2 in accordance with the invention comprises a base plate 20 and a load bearing assembly 30 as discussed in detail below.

The base plate 20 is formed of metal and is a disc shaped member. The base plate 20 comprises two opposite units each including an elongated slot 21, a bent latch 22 of substantially L shaped facing forward, and a tab 24 on an inner surface of the latch 22 facing rearward. A gap 23 is formed between the latch 22 and a hole (not numbered) through the base plate 20. The latches 22 and thus the hole through the base plate 20 are formed by punching in the manufacturing process.

The load bearing assembly 30 can be made of metal or other materials. The load bearing assembly 30 comprises a load bearing member 31 including a disc element 312 having an annular flange (not numbered) to form a shallow space, two spaced bossed holes 313 each having internal threads 314, and a hook 311 projecting forward from a center of the disc element 312; a separate, elongated plate member 32 including two opposite units each having a recess 323 proximate to one side and a through hole 321 adjacent the recess 323, and two opposite cutouts 322 each formed on edge between the units; and two screws 33.

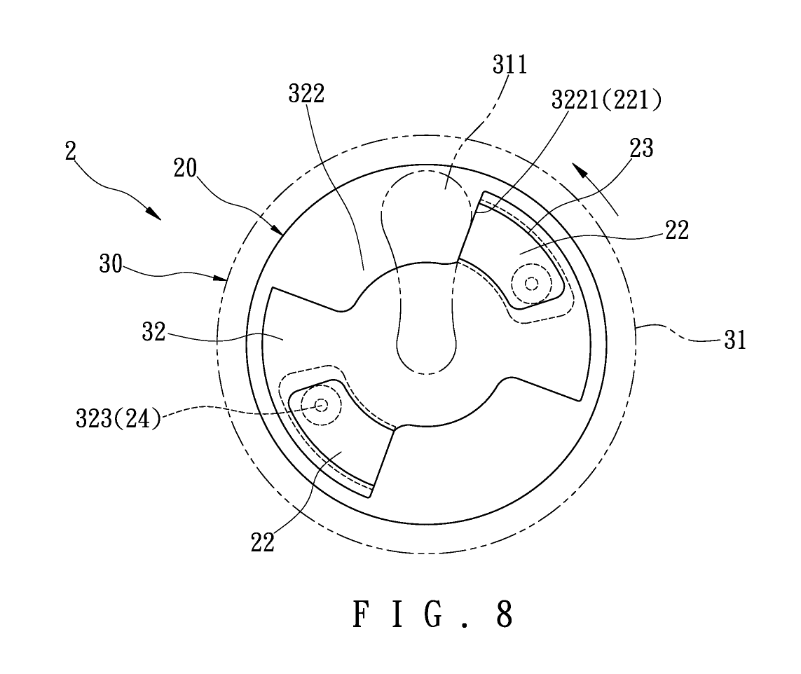

An assembly of the invention is described in detail below. Two screws 25 are driven through the slots 21 into a vertical surface (e.g., wall) 3 to secure the base plate 20 thereto. The screws 33 are driven through the through holes 321 into the threads 314 respectively to secure the plate member 32 and the load bearing member 31 together. That is, the plate member 32 is fixed in the shallow space on the back of the disc element 312 and is spaced from the back of the disc element 312. The spacing between the disc element 312 and the back of the disc element 312 is substantially the same as the thickness of the latch 23. Also, the thickness of the plate member 32 is substantially the same as the gap 23. The plate member 32 can be attached to the base plate 20 by aligning the cutouts 322 with the latches 22 respectively. Next, as shown in FIG. 8, the plate member 32 is turned counterclockwise an angle until the tabs 24 are complimentarily received in the recesses 323 (i.e., locked). This completes the assembly.

An individual may hang an object on the hook 311 in use. It is envisaged by the invention that the hook 311 can support a predetermined load without being damaged or causing the load bearing assembly 30 to disengage from the base plate 20 since the fastening of the base plate 20 and the load bearing assembly 30 is secure and reliable.

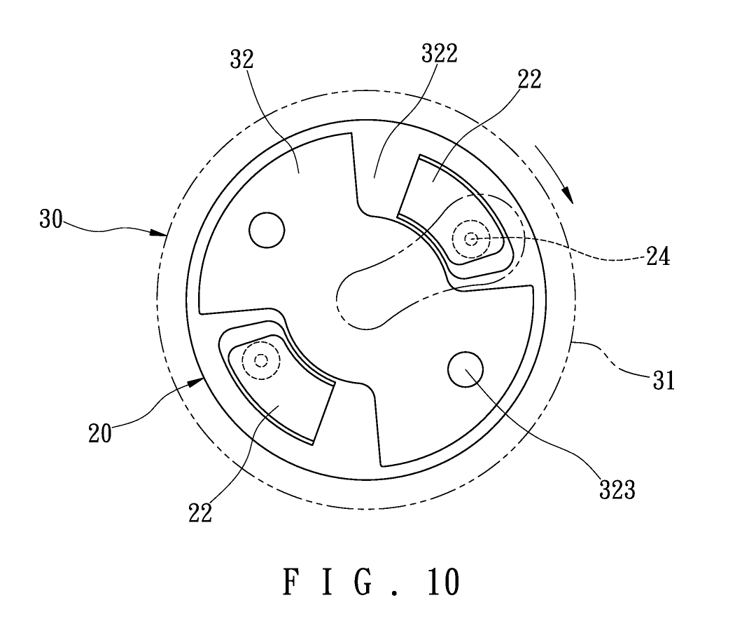

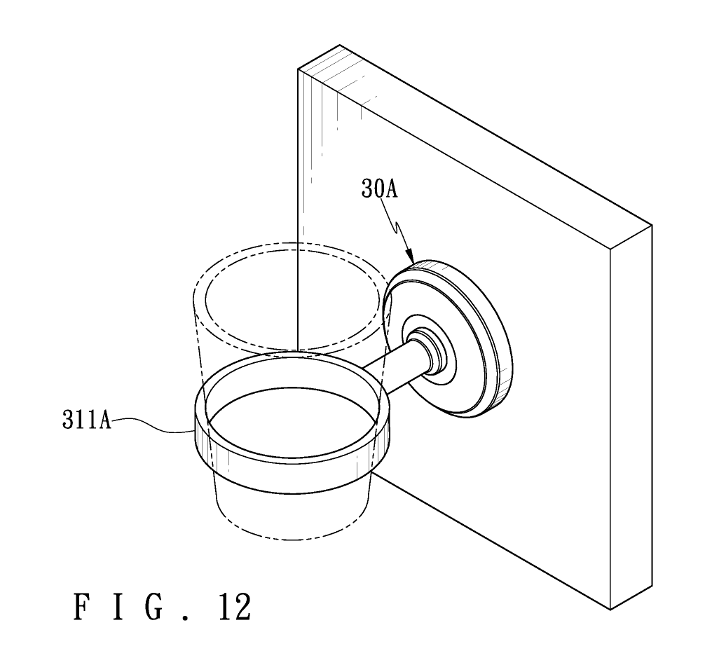

An individual may clockwise turn the load bearing assembly 30 to disengage the recesses 323 from the tabs 24 (see FIG. 10). Thereafter, the load bearing assembly 30 is detached from the base plate 20. Referring to FIG. 12, the individual may replace the load bearing assembly with another load bearing assembly 30A. The load bearing assembly 30A is different from the one shown in FIGS. 2 to 11 by replacing the hook with a retainer ring 311A which is fixedly secured to and spaced from the load bearing assembly 30A by means of an integral bar (not numbered). In use, a cup (not numbered) can be supported by the retainer ring 311A.

In brief, an individual may replace the existing load bearing member with a new in case of damage. Alternatively, an individual may replace the existing load bearing member with a different one and the only difference between the two load bearing members is that, for example, a hook is replaced with another member for load bearing purpose (e.g., retainer ring). That is, the holder of the invention has a replaceable load bearing member. This has the benefits of being adaptable, saving cost of without buying a new holder if only the load bearing member is damaged, and easy assembly and disassembly.

While the invention has been described in terms of preferred embodiments, those skilled in the art will recognize that the invention can be practiced with modifications within the spirit and scope of the appended claims.

What is claimed is:

1. A holder comprising:
a base plate adapted to secure to a vertical surface and comprising two locking units on a front surface; and
a load bearing assembly comprising a load bearing member, a load bearing element projecting forward from the load bearing element; and a plate member releasably secured to the load bearing element,
wherein the locking units are releasably fastened between the load bearing member and the plate member.

2. The holder of claim 1, wherein the base plate further comprises two slots so that a threaded fastener can be driven through each slot into the vertical surface for fastening.

3. The holder of claim 1, wherein each of the locking units comprises a bent latch formed by punching the base plate, the latch being spaced from the base plate by a gap.

4. The holder of claim 3, wherein each of the latches comprises a mating member on an inner surface facing rearward, and wherein the plate member comprises two corresponding mating members facing forward, each corresponding mating member being adapted to lockingly engage with the mating member.

5. The holder of claim 4, wherein each mating member is a tab and each corresponding mating member is a recess.

6. The holder of claim 1, wherein the load bearing member comprises two bossed threaded holes on a recessed back, and wherein the plate member comprises two through holes so that a threaded fastener can be driven through each though hole into the bossed threaded hole to fasten the plate member at a distance from the back of the load bearing member.

7. The holder of claim 3, wherein the plate member comprises two opposite cutouts each formed on edge so that the plate member is adapted to attach to the base plate by aligning the cutouts with the latches respectively.
